(19) United States
(12) Patent Application Publication
(10) Pub. No.: US 2009/0289864 A1
(43) Pub. Date: Nov. 26, 2009

(54) Antenna Arrangement And A Method Relating Thereto

(76) Inventors: Anders Derneryd, Goteborg (SE); Sven Oscar Petersson, Savedalen (SE); Stefan Johansson, Romelanda (SE); Martin Nils Johansson, Molndal (SE)

Correspondence Address: ERICSSON INC., 6300 LEGACY DRIVE, M/S EVR 1-C-11, PLANO, TX, 75024, US

(21) Appl. No.: 11/721,418

(22) PCT Filed: Dec. 13, 2004
(86) PCT No.: PCT/SE04/01854

§ 371 Date: Aug. 4, 2009

(51) Int. Cl. H01Q 3/00; H01Q 21/00

(52) U.S. Cl. 343/758; 343/757; 343/893

(57) ABSTRACT

The present invention relates to an antenna arrangement (100) comprising an antenna section, said antenna section comprising a number of radiating elements which may be arranged in arrays or sub-arrays. It further comprises at least one further antenna section, said at least two antenna sections (101,102,103) being mounted substantially along a straight line, a non-straight line or irregularly at a mounting structure (40). It comprises a feeding network arrangement (20) for feeding said at least two antenna sections (101,102,103), with feeding network control means for controlling the feeding of the antenna sections (101r 102, 103) allowing for beam forming control.

### FIELD OF THE INVENTION

The present invention relates to an antenna arrangement comprising an antenna section with a number of radiating elements which may be arranged in sub-arrays. The invention also relates to a method for controlling the beam forming in an antenna arrangement comprising an antenna section which in turn comprises a number of radiating elements which may be arranged in sub-arrays.

### STATE OF THE ART

Antennas used today at the radio base stations of cellular mobile communication systems often are of the sector type. Three, six or more such antennas then cover, together, 360 degrees in azimuth. It is generally desirable to be able to extend the coverage of the radio base station. Then, however, high gain antennas are needed. Generally, the mechanically longer the antenna, the easier it is to provide a higher gain without altering the azimuth beam-width. However, even if mechanically long antennas are attractive for the reason mentioned above, there are several drawbacks associated with mechanically long antennas. First, mechanically long antennas are cumbersome to handle, to transport and to mount. Installation gets time-consuming and expensive. Moreover, means for tilting down the beam would have to be incorporated in order to reduce interference in neighboring cells. Such means may be mechanical and/or electrical. As far as the provision of tilting is concerned, also in this respect there are several drawbacks associated with long antennas. Pure mechanical tilt of a long antenna may result in the antenna deviating quite a lot from a vertical line, which means that it will typically not be parallel to the mast on which it is mounted. Moreover, for mechanical tilting, a high wind load will result in a large torque which may cause damage to the antenna and may make it malfunction and it may even make it vulnerable to breaking entirely. Moreover if the antenna is really long, a lot of mechanical tilting may be required; such antennas will be unaesthetic and the higher the antenna, the longer the required mechanical deviation and the more severe the drawbacks.

If on the other hand pure electrical tilt for a long antenna, with a given number of radiating elements, is implemented with only one or very few elements per sub-array, this requires a substantial amount of hardware. Increasing the number of radiating elements per sub-array and thus reducing the number of sub-arrays reduces the amount of hardware. However the scan range will also be reduced due to grating lobes resulting in gain reduction and reduced spatial filtering, which is disadvantageous.

Hence, so far no satisfactory solution has been suggested concerning the issue of providing an antenna which is as long as would be desirable for example from a coverage or gain point of view.

### SUMMARY OF THE INVENTION

Therefore an antenna arrangement as initially referred to is needed which can be made long (mechanically), and which despite that is easy to fabricate or achieve, easy to install, easy to transport and which can be fast and easily mounted. Particularly an arrangement is needed which can be given a high gain without requiring alteration of the azimuth beam-width. Particularly an antenna arrangement is needed, which has an excellent coverage and a high gain, and for which interference can be reduced in neighbouring cells.

Still further an antenna arrangement as initially referred to is needed which is aesthetic, and even more particularly an antenna arrangement is needed which is not so vulnerable to the exposure to high wind, particularly not suffering from a large torque being produced due to hard or extreme whether conditions such as hard wind.

Particularly an arrangement as initially referred to is needed through which tilting can be provided for in an easy manner and without requiring large amounts of equipment or hardware. Thus, particularly an antenna arrangement is needed which is compact, i.e. not cumbersome, and which does not extend too much in a direction perpendicular to the longitudinal, particularly but not necessarily vertical, extension of the mast or other structure on which it is mounted. Even more particularly an arrangement is needed which allows the use of existing antenna parts or commercially available “off-the-shelf” antennas as well as the use of for the purpose designed antennas. Even more particularly an antenna arrangement is needed for which the beam forming can be controlled and/or such the gain can be controlled in an easy manner. Still further an antenna arrangement is needed which is flexible and which allows a high degree of controlling and adaptation to various conditions. Even more particularly an antenna arrangement is needed through which a reduced scan loss can be provided or particularly through which an increased tilt range is allowed before the on-set of grating lobes as compared to an electrically-only tilted antenna with large sub-arrays is concerned.

Therefore an antenna as initially referred to is provided which, in addition, comprises at least one further antenna section also comprising a number of radiating elements which may be arranged in sub-arrays respectively, wherein said at least two antenna sections are mounted substantially along a straight line or somehow irregularly, e.g. not on a straight line on a mounting structure. The antenna arrangement further comprises a feeding network for feeding said at least two antenna sections, and feeding network control means for controlling the feeding of the antenna sections allowing for beam forming control. The antenna arrangement can be implemented in many different ways. The antenna sections may be specifically manufactured, designed or marketed for the inventive antenna arrangement, but it is also possible to use conventional, off-the-shelf antenna sections for mounting according to the inventive concept. It should be clear that the antenna sections preferably are separate units.

In one embodiment at least two of said number of antenna sections are substantially identical. Even more particularly all antenna sections are substantially identical or entirely identical. In another implementation at least two antenna sections are non-identical, i.e. different or, even more particularly, all antenna sections are different or non-identical.

The antenna sections may also be mounted in several different ways. In one embodiment the antenna sections are so mounted that the spacings between respective adjacent antenna sections (pair-wise) are substantially equal. In another embodiment the antenna sections are so mounted that the respective spacings between respective adjacent antenna sections (pairs) are different or that some spacings are equal whereas one or more other spacings are different. In one particular embodiment the antenna sections comprise conventional sector antennas, e.g. with a 45°, 60° or 90° beam-width in azimuth. These two features may also be combined in any manner, e.g. non-equal antenna sections may be combined with different spacings etc.

The feeding network arrangement particularly comprises means for variably controlling the phase and/or the amplitude between the sections of the multi-section antenna, hence allowing for phase and/or amplitude tapering, or providing for the provisioning of different feeding signals, i.e. for adapting the feeding signal differently as far as phase and/or amplitude is concerned, to the respective sections. Particularly it comprises means for tilting the beam in relation to the normal of a real or virtual mounting plane on which carrying means, e.g. a mast, is mounted for carrying the antenna arrangement consisting of said antenna sections.

In one particular embodiment the means for tilting the beam comprises mechanically tilting means for mechanically tilting the antenna sections. Preferably at least two or most advantageously all antenna sections are individually mechanically tilted.

In another embodiment the antenna sections are electrically pre-tilted, i.e. comprise a “built-in” beam tilt, which may be the same for all antenna sections or different for different antenna sections, or none at all for one or more sections. Particularly some or all antenna sections are provided with a controllable electrical pre-tilt which is “built in”, i.e. they are equipped with an electrical tilt.

According to another embodiment the arrangement comprises means, particularly provided for through the feeding network arrangement, for electrically tilting the multi-section antenna. The means for electrical tilting the multi-section antenna arrangement particularly comprises phase delay means and/or time delay means in or associated with the feeding network operative in such a manner that respective phase delays and/or time delays may be introduced for the respective antenna sections such that a feeding signal having the appropriate phase delay and/or time delay can be provided to each one of the respective antenna sections.

In specific embodiments a mechanical tilting means is combined with electrical tilting (“pre-tilt” and/or by means of the feeding networks, or delay means/phase shifters etc., provided electrical tilting). Hence, particularly mechanical tilting and electrical tilting provided for through the feeding network (or specific means) as described above may be combined in any desired manner.

In the case of mechanical tilting, separately or individually applied to the different antenna sections, the displacements of the antenna sections that are produced when the panels are tilted individually, are compensated for through the feeding network. Also when the antenna sections are pre-tilted or pre-equipped for the application of an electrical tilt of each antenna section individually, the displacement of phase-fronts from the individual antenna sections that arises from the electrical tilting operation has to be compensated for, preferably through the feeding network.

Through the implementation of mechanical tilting on a per antenna section level (combined or not with electrical tilting either with pre-equipped antenna sections or through controlling on antenna section level) mechanical tilting on an antenna section level enables a compact antenna multi-section arrangement as compared to antenna arrangements, where the entire antenna or the entire structure is mechanically tilted. This, for example, considerably reduces the effects of strong wind and hence the torque resulting from the wind will be reduced and at the same time the antenna arrangement will be slimmer and more aesthetic. Similarly, through the introduction of electrical tilting on an antenna section level instead of on antenna sub-array level, the required amount of hardware that is needed will be considerably reduced.

Hence, a combination of electrical and mechanical tilting is possible, and, when required, compensation for phase-front displacements is provided for through the feeding network or through control means controlling the feeding network, or separate compensation means.

In one particular implementation the feeding network arrangement comprises two feeding networks, each feeding the antenna sections with a respective polarization. Particularly the same feeding signal is used to feed a first and a second polarization and the respective feeding networks comprise control means for controlling the elevation beam pattern of the respective polarizations, particularly to obtain elevation beam patterns of the respective polarizations which have a complementary elevation coverage, such that a combined pattern being the power sum of the respective elevation beam patterns is generated. For that purpose, each feeding network may particularly comprise a multi-port elevation feeding network, which for example is based on a Butler matrix network.

Most preferably the/each feeding network comprises power splitting means for appropriately splitting power fed to the respective antenna sections. In one implementation the power is split equally between the antenna sections, particularly if they are identical. Similarly, in case the, or some, sections are not identical, the power may be split such as to give an equally power distribution per unit length, over the multi-section antenna arrangement. Such types of feeding networks are particularly efficient in terms of maximizing the antenna gain. If other parameters than the gain are of importance, such as for example side lobe level, the power distribution may be controlled or optimized accordingly. The means that are used, separately or in any combination for beam forming or beam shaping, operate to control one or more of the amplitude taper, phase taper, antenna section electrical and/or mechanical tilting, the spacing between antenna sections or to provide for different polarizations.

These means are, according to some embodiments of the invention, used for beam forming or beam shaping for the purposes of controlling the radiation pattern such that one or more “nulls”, i.e. very low antenna gain, or none at all, in some directions, e.g. between main beam and side lobes, or between side lobes, can be “filled”, i.e. the gain drop be reduced to an acceptable level, or entirely inhibited.

Any of the means referred to above can be used, alone or in various combinations with each other. Particularly the phase can be distributed differently to different antenna sections (providing for phase taper), the power can be distributed unequally to different sections, hence providing for amplitude taper, sections can be tilted differently (mechanically and/or electrically), antenna sections may be displaced differently and/or be non-identical. Still further radiation patterns with different polarizations can be used.

Null-filling may be combined with beam tilting in any combination that is appropriate for the relevant application.

It should be clear that the multi-section antenna arrangement is used for transmission or reception or transmission and reception.

In one implementation the arrangement comprises three antenna sections mounted on a common mast. More generally it may comprise between 2 and 6 or, in some cases, even more antenna sections mounted on a common mast or other structure.

Particularly an arrangement as discussed above is used in a radio base station of a cellular mobile communication system.

The invention therefore also suggests a method for controlling beam forming in an antenna arrangement comprising a number of antenna sections, each comprising a number of radiating elements which may be arranged in sub-arrays. The method comprises the steps of, in an antenna arrangement as referred to above and which composes at least two antenna sections mounted substantially along straight line, e.g. on a mast or some other structure; feeding the antenna sections by means of a feeding network; controlling the feeding, preferably while mechanically and/or electrically applying an individual beam tilt to the respective antenna sections and/or controlling the disposition of antenna sections, in relation to each other and/or the shapes/sizes of the respective antenna sections in order to control the gain and/or beam form.

Particularly the method includes the step of; compensating for displacement of the phase fronts from the respective antenna sections caused by mechanical tilting and/or electrical tilting obtained through antenna sections equipped therefore, using the feeding network.

The method furthermore advantageously comprises the step of; applying individual time delays and/or phase shifts to the respective antenna sections feeding signals in order to provide for electrical beam tilting or null-filling. In one particular embodiment the method comprises the step of; using a first feeding network for, using a feeding (RF) signal, feeding a first polarization to the antenna sections, and using a second feeding network for, using the same feeding (RF) signal, feeding a second polarization to the antenna sections. Particularly the method then comprises the step of using multi-port elevation feeding networks, e.g. based on Butler matrix networks, to provide multiple beams for each polarization. Particularly the method comprises the step of manually controlling the feeding network arrangement. Alternatively the method comprises the step of remotely, by means of a remote control unit or similar, controlling the feeding network arrangement. The feeding network arrangement may also be automatically controlled.

### BRIEF DESCRIPTION OF THE DRAWINGS

The invention will in the following be further described, in a non-limiting manner, and with reference to accompanying drawings, in which:

FIG. 1 shows an antenna arrangement, according to the state of the art, which is mechanically tilted,

FIG. 2 shows an antenna arrangement according to one embodiment of the present invention wherein the antenna arrangement consists of three antenna sections which are individually mechanically tilted,

FIG. 3 illustrates a first implementation of a feeding network for feeding three antenna sections comprising a power splitter and fixed phase shifts,

FIG. 4 shows a second embodiment of a feeding network providing for a power splitting to three separate antenna sections and which comprises variable phase shifting means,

FIG. 5 shows a third embodiment of a feeding network which comprises a power splitting means and which comprises variable time delaying means,

FIG. 6 shows a further embodiment of an antenna arrangement according to the invention with a feeding network comprising power splitting means and time delaying means,

FIG. 7 very schematically illustrates still another implementation of an antenna arrangement according to the invention wherein the antenna sections are unequally displaced in relation to one another,

FIG. 8 shows still a further embodiment of an antenna arrangement according to the invention wherein non-identical, i.e. different, antenna sections are used,

FIG. 9 shows an antenna arrangement with electrically tilted antenna sections,

FIG. 10 is a diagram showing the lobes for an antenna arrangement with electrical and mechanical tilt as compared to antenna arrangement with electrical tilt only,

FIG. 11 is a cross-sectional view of the radiation pattern provided by an antenna arrangement at a radio base station, and with a narrow beam in elevation, with and without null-filling,

FIG. 12 is a diagram illustrating a comparison between an arrangement in which three identical antenna sections have different relative amplitude tapers and an arrangement with no amplitude taper,

FIG. 13 shows a diagram of radiation patterns illustrating a comparison between an arrangement in which phase taper is provided between antenna sections for null-filling purposes, and one where the taper is uniform,

FIG. 14 shows the radiation pattern for an arrangement implementing mechanical tilt in combination with amplitude taper for null-filling purposes as compared to an arrangement without mechanical tilt and amplitude taper,

FIG. 15 is a diagram of the radiation pattern for an arrangement comprising phase taper between antenna sections in addition to electrical tilt as compared to an arrangement where there is no electrical beam tilt and no phase taper,

FIG. 16 shows a diagram illustrating the radiation pattern for an arrangement in which the antenna sections are displaced differently (cf. FIG. 7) for purposes of null-filling, as compared to an arrangement having uniform spacing,

FIG. 17 shows an antenna arrangement according to an embodiment of the invention with dual-polarized antenna sections, and

FIG. 18 is a diagram showing that the null-filling is not deteriorated when tilting is applied.

### DETAILED DESCRIPTION OF THE INVENTION

For the further understanding of the document, the terminology that is used will be briefly explained. An antenna element here designates an individual radiating element; mostly however, the term radiating element is used in the present document. A sub-array here means a group of antenna elements, i.e. radiating elements, which are arranged in such a way that they have a certain relation to each other. They are typically located on a straight line with equal or unequal spacing between respective antenna elements or radiating elements. An antenna section is a physical unit. It may for example be an off-the-shelf antenna or an antenna section fabricated specially for the purpose of providing a multi-section antenna. The antenna section may generate one or more beams, for example a dual polarized antenna. Particularly there is one RF-connector per beam. An antenna section may be a commercially available antenna, for example a sector antenna with 45°, 60° or 90° beam-width in azimuth. It may however also be a specifically designed antenna section.

In an antenna arrangement according to the present invention or more shortly a multi-section (i.e. at least two sections) antenna, a certain number or a group of separate antenna sections are so arranged that they have a certain relation to each other. Generally they are located on a substantially straight line and, in different embodiments the spacing may be equal or different between respective antenna sections. Also, according to different embodiments, the antenna sections may be identical or different, or some of the antenna sections within a multi-section antenna arrangement may be identical whereas others are different.

The fundamental idea of the present invention is to provide long antennas or long antenna arrangements, particularly for use in cellular mobile communications systems by using two or more separate antenna sections, or more generally antennas, which may be commercially available as well as specifically designed for the purpose, and which are connected to a feeding network. Generally a mechanically longer antenna will give a higher gain and hence an extended coverage without altering the azimuth beam-width. According to different embodiments mechanical and/or electrical tilting of the beam may be incorporated for example in order to maximize path gain and/or to reduce interference that may be produced in neighboring cells. However, the invention is not restricted to the provisioning of any particular kind of tilting or tilting at all. Anyhow, according to the basic concept, if tilting is produced in any way it may also be used for other purposes. In the following reference will be made to the accompanying figures.

FIG. 1 shows a state of the art antenna arrangement 100₀ comprising an antenna 10₀ connected to a mast 40₀ and fed by a feeding network (not shown) over a feeder cable 30₀. The shown antenna 100 is tilted by means of a mechanical tilting device, 50₀. Such an antenna arrangement, however, suffers from the drawbacks referred to earlier in the document.

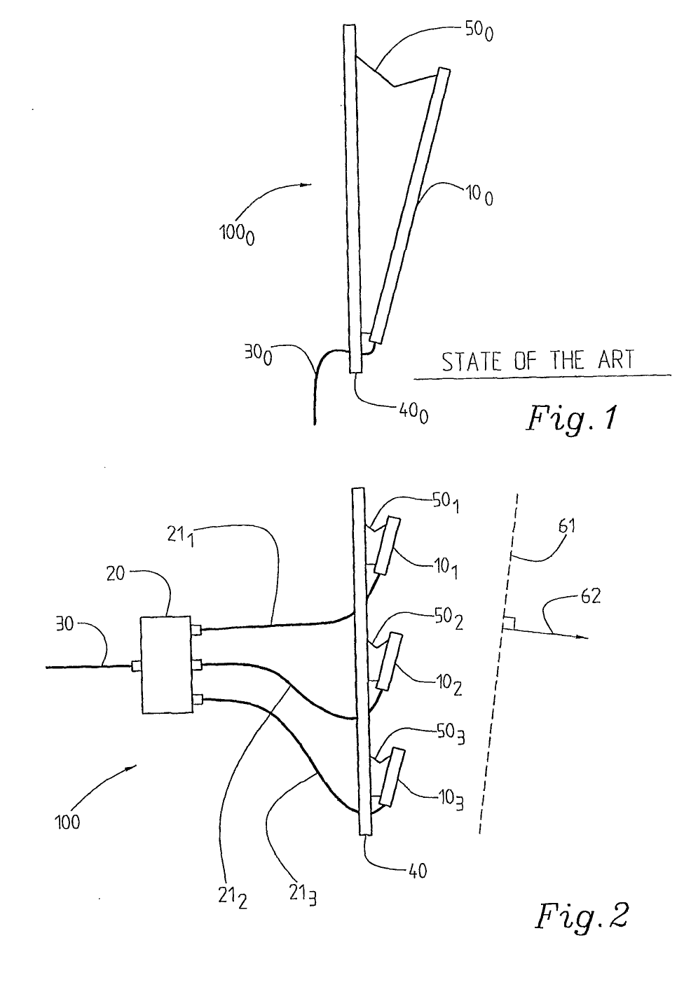

FIG. 2 shows an antenna arrangement 100 according to the present invention, which comprises three antenna sections 10₁, 10₂, 10₃ all connected substantially along a straight line to a mast 40. The antenna sections 10₁, 10₂, 10₃ are fed by means of a feeding network 20 to which they are connected by feeding cables 21₁, 21₂, 21₃ which here have unequal lengths to compensate for the phase deviation in the RF path from the common feed point through the different antenna sections and to the far field in the desired beam direction 62. A common, main feeder cable 30 feeds the feeding network. In this embodiment the antenna sections 10₁, 10₂, 10₃ are mechanically tilted by means of mechanically tilting means 50₁, 50₂, 50₃ and they may be provided for other kind of tilting i.e. antenna section beam direction does not have to coincide with the desired beam direction 62 of the multi-section antenna arrangement. The dotted line 61 in the figure illustrates the common phase front from the antenna sections after compensation. In this embodiment it is supposed that all the antenna sections are non-equal and that the spacing between them is non-equal and they are not mechanically tilted in one and the same way. This is one way of beam forming or beam shaping that is enabled according to the present invention.

Generally the feeding network 20 may operate in different ways and be controlled by control means, either included in the feeding network or the feeding network may be somehow connected thereto; the controlling may be performed manually or remotely depending on implementation.

The simplest and most straight-forward way to distribute power between the respective antenna sections is to split power equally between the antenna sections when they are identical. If the antenna sections are not identical, the power may be split e.g. using a power splitter to provide an equal power distribution, per unit length, over the antenna arrangement. Such a feeding network is efficient in terms of maximizing the gain of the antenna arrangement.

However, also other parameters than the gain may be of considerable importance, such as for example side lobe level, and then the feeding network (signal distribution) may, according to different embodiments, be optimized for such other parameters as well, or only for such parameters.

As will be more thoroughly explained below, there are several means for performing a beam forming, or beam shaping. Some of the means or actions that can be used are for example provision of an amplitude taper, a phase taper, an antenna section tilt (on a per section level), through providing non-equidistant spacing between antenna sections and by mixing polarizations.

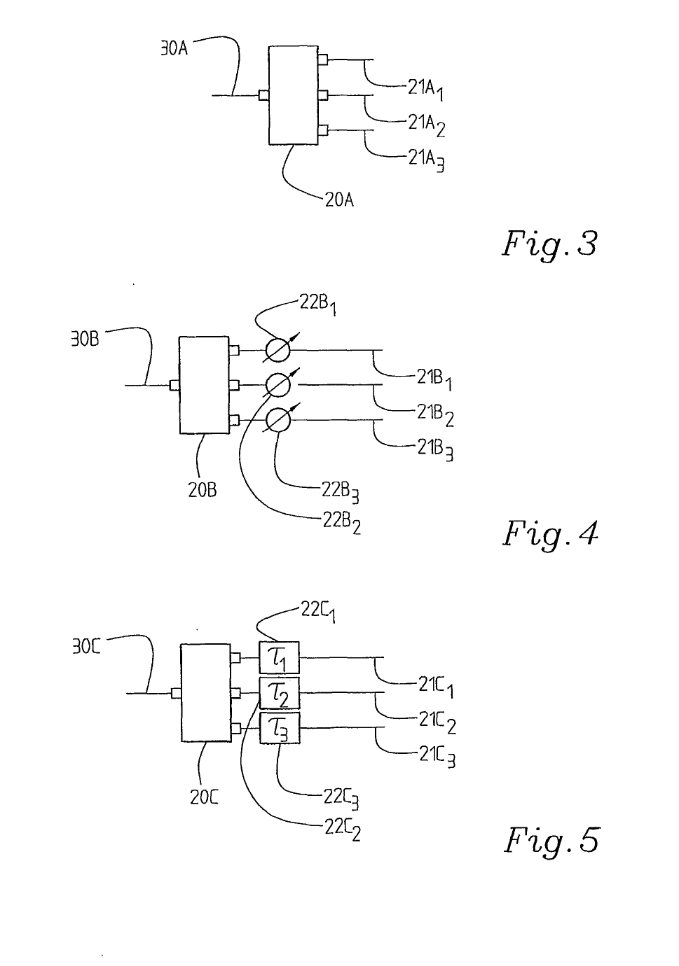

As referred to above the feeding network used to distribute the signal between the respective antenna sections can be of different complexity, everything from a very simple feeding network simply comprising an (equal) power splitter (and fixed phase shifts) as shown in FIG. 3 wherein the feeding network 20A comprises a power splitter/combiner with feeding cables 21A₁, 21A₂, 21A₃ of different lengths connecting to the respective antenna sections (not shown), wherein a common feeder cable 30A feeds the feeding network 20A.

FIG. 4 shows another example of a feeding network 20B which is somewhat more complex and comprises a variable, unequal power splitter/combiner and variable phase shifters 22B₁, 22B₂, 22B₃ connected to the respective antenna sections (not shown) over feeding cables 21B₁, 21B₂, 21B₃ of equal lengths. Like in the preceding embodiment the feeding network is fed by one feeder cable 30B.

FIG. 5 shows still another implementation of a somewhat more complex feeding network 20C comprising a variable unequal power splitter/combiner and variable time delay means 22C₁, 22C₂, 22C₃ for appropriately delaying the respective feeding signals to the respective antenna sections (not shown) over feeding cables 21C₁, 21C₂, 21C₃ with equal lengths. The feeding network 20C is fed by a feeding cable 30C like in the preceding embodiments. As referred to earlier, controlling of the amplitude and time delay settings in the feeding network may be performed manually or remotely by means of a control system (not shown) which may be incorporated in the feeding network, or stand-alone.

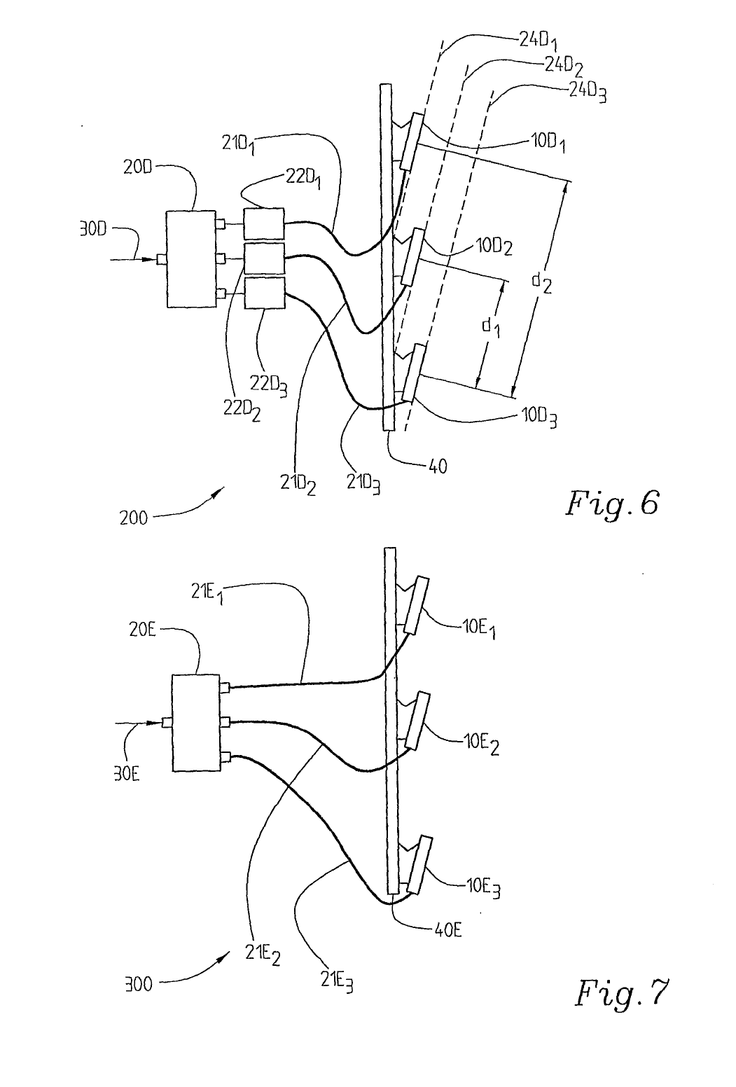

FIG. 6 illustrates an antenna arrangement 200 using a feeding network similar to the feeding network described in FIG. 5 in that it comprises variable time delaying means (τ₁, τ₂, τ₂) 22D₁, 22D₂, 22D₃. However, the feeding network 20D is connected to the three antenna sections 10D₁, 10D₂, 10D₃ which here are equal and equidistantly connected, over feeding cables 21D₁, 21D₂, 21D₃ of equal lengths. (According to another implementation, not shown, it is possible to achieve required time delays by using cables of predetermined lengths.) It is here supposed that the antenna sections 10D₁, 10D₂, 10D₃ are identically mechanically tilted an angle α.

The mechanical tilt angle α from a vertical axis is identical and the phase fronts for each antenna section illustrated through the dotted lines in the figure (24D₁, 24D₂, 24D₃) are parallel since it is supposed that there is no electrical beam tilt within each antenna section. The deviation between the phase fronts emanating from the mechanical tilt of the respective antenna section needs to be compensated for in order to achieve a coherent superposition of the complex radiation pattern of each antenna section. The displacement of the phase fronts between the antenna sections, independently of whether the difference is generated by a pure mechanical tilt, a pure electrical tilt or a combination thereof, may be due to a respective time delay. For maximum signal level the time advance for antenna section n is given as:

τₙ=dₙ tan (α)/c,

dₙ being the distance between phase centers and c being the speed of light.

For a feeding network similar to the one of FIG. 4, in which instead phase shifters are used, the corresponding phase advance will be given as:

Θₙ=2πdₙ tan (α)/λ,

λ being the RF signal wavelength.

A phase advance is usually implemented as Θₙ modulo 2π radians (360°).

FIG. 7 schematically illustrates another implementation of an antenna arrangement 300 according to the present invention. Three substantially identical antenna sections 10E₁, 10E₂, 10E₃ are mounted substantially along a straight line, e.g. on mast 40E. However, in this case, the distances between the respective antenna sections are different and antenna section 10E₃ can be said to be displaced in relation to the antenna section 10E₂. The distance between antenna section 10E₂ and 10E₃ is for example the sum of the distance between antenna sections 10E₁ and 10E₂ and half the length of antenna section 10E₃ (which in this case is the same as the length of the other antenna sections) in the same direction. The antenna sections 10E₁, 10E₂, 10E₃ are via cables 21E₁, 21E₂, 21E₃ connected to feeding network 20E which is fed by feeder cable 30E. It would of course also have been possible to have antenna sections of different sizes, i.e. which are non-identical (they may also be non-identical from other aspects than size), two identical may be used whereas the third is different etc. Any variation in size as well as in antenna section separation are in principle possible. Of course there is no limitation to the use of three sections, it may be more as well (and fewer in other embodiments which do not provide for at least two different distances between respective antenna sections).

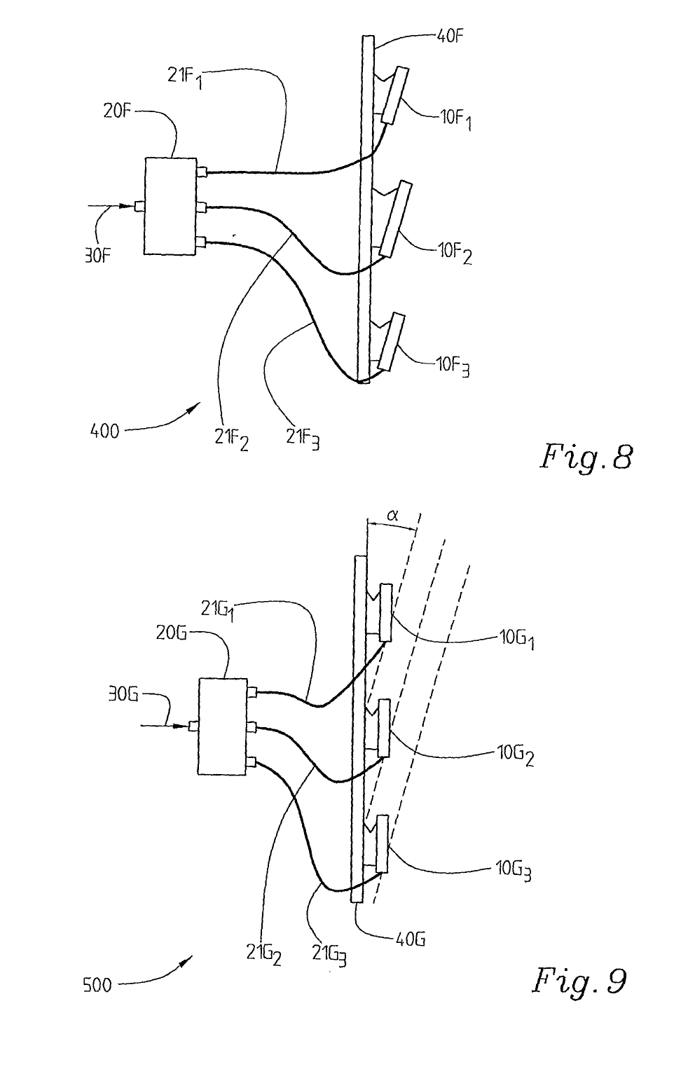

In FIG. 8 still another embodiment is disclosed, showing an antenna arrangement 400 which also here comprises three antenna sections 10F₁, 10F₂, 10F₃ which via feeding cables 21F₁, 21F₂, 21F₃ are fed by feeding network 20F which in turn is fed by feeder cable 30F. However, in this case, the antenna sections are non-identical; in this particular case it is supposed that antenna section 10F₁ and antenna section 10F₃ are identical whereas antenna section 10F₂ is larger. For arrangements with at least two antenna sections, antenna sections with different sizes can be used. Antenna section 10F₁ may of course have another size or alternatively antenna section 10F₃. Any variation is in principle possible. In FIG. 8 the distances are the same between the respective antenna sections; also the distances might of course have been different as referred to above. It should also be clear, that although in all the illustrated antenna arrangements only three antenna sections are illustrated, actually in any or almost in all cases it would be possible to have for example two antenna sections, four antenna sections, five, six, seven or eight or any appropriate number but for reasons of clarity this is not explicitly illustrated in any figure.

As referred to above it is often, for different reasons, desirable to be able to tilt the beam in relation to the normal of a (virtual) mounting plane. Generally the purpose of tilting the beam is to direct the radiated power to desired locations within a cell. Beam tilting may for example be required when the horizon or the cell border is “below a horizontal plane at the base station”, for example due to a high mast or due to altitude variations in the landscape. Another reason for tilting the beam may be that the antenna arrangement should be mounted along a non-vertical axis.

Beam tilt is a well-known and commonly used technique in current feeding networks. Generally there are two different implementations, namely electrical tilt, where the beam is tilted by means of applying time delays cf. FIG. 5, FIG. 6 or phase shifts, cf. FIG. 4, over the antenna, the other being mechanical tilt where the antenna is physically mounted such as to achieve the desired beam direction. These two techniques can also be combined giving additional flexibility to control the properties and characteristics of the antenna arrangement. However, according to the present invention it is the antenna sections that are applied with time delays or phase shifts or electrically mounted in a particular way, i.e. the electrical and/or mechanical beam tilt does not only relate to a single antenna, i.e. one section, but to two or more separate antenna sections. In addition thereto each antenna section may be pre-equipped with a built-in electrical beam tilt means, i.e. antenna can be said to be pre-tilted.

Hence, according to the invention (if tilting is implemented) each antenna section is individually tilted, or, if there are more than two antenna sections, it is of course possible to tilt for example two of the antenna sections commonly whereas a further antenna section (or more) is/are tilted individually.

As referred to above, the displacements of the phase fronts that occur when antenna sections are tilted individually, are compensated for in the feeding network.

Due to the fact that mechanical tilt is provided per antenna section, or that at least two antenna sections are tilted individually, it is possible to obtain a much more compact installation than if an entire structure, i.e. an entire antenna, is mechanically tilted (cf. FIG. 1). A particular advantage consists in that the torque produced from strong wind is reduced and at the same time it is possible to provide a more aesthetic installation.

Electrical tilting will in the following be described in a somewhat more detailed manner.

First an electrical tilt can be implemented by means of applying electrical tilt within each antenna section individually if the antenna sections are pre-equipped for such tilting means. The displacements of phase fronts from the individual antenna sections that arise from the electrical tilt operations then have to be compensated for in the feeding network, cf. equations described above. Of course also in this case, (similar to when mechanical tilting is provided), it is possible to apply a respective tilt individually only to a limited number of the antenna sections of the antenna arrangement or an equal tilt to all or a limited number only, or different tilts to all sections. Any variation is in principle possible.

Another way is provide to an electrical tilt between antenna sections. An electrical beam tilt of a long antenna would require a substantial amount of hardware when implemented as steering on sub-array basis with only one or a few antenna elements per sub-array. The amount of hardware is, according to the present invention, reduced considerably by applying the electrical steering on antenna section level. Beam tilt may then be applied by introducing the proper time delays or phase shifts only in the feeding network.

FIG. 9 schematically illustrates an antenna arrangement 500 exemplifying such an embodiment in which to each antenna section certain electrical tilt is applied. Hence proper time delays and/or phase shifts are introduced in the feeding network 20G which feeds the individual antenna sections 10G₁, 10G₂, 10G₃ individually over feeding cables 21G₁, 21G₂, 21G₃, the lengths of which are non-equal. In addition to only compensating for the deviation in phase fronts the feed network may also apply a desired beam tilt, different from the one given by the individual antenna sections. This beam tilt range may be limited due to onset of grating lobes since the antenna section distance is large.

It should be clear that mechanical tilt and electrical tilt can be combined in any manner.

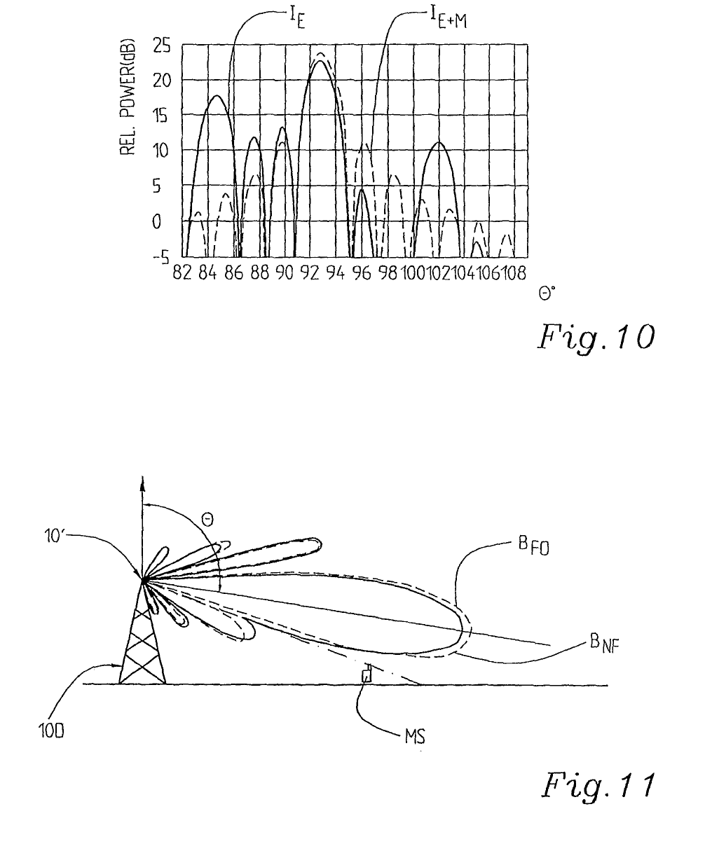

FIG. 10 is a diagram describing the relative power in dB versus Θ°, Θ being defined in FIG. 11 below. This figure (FIG. 10) relates to an example of an antenna arrangement (not explicitly shown) with four antenna sections with eight antenna elements spaced 0.82 wavelengths apart. In the figure the solid line (I_{E}) describes the radiation pattern for three degrees beam tilt with only electrical tilt of antenna sections whereas the dashed line (I_{E+M}) illustrates a combined electrical and mechanical tilt of antenna sections. Hence, the solid line shows a main beam and the first side lobes for the case with phase settings of each antenna section to scan the beam three degrees (no electrical beam tilt within each antenna section). Grating lobes are generated due to the large spacing. The grating lobes may be avoided if the antenna sections are mechanically tilted three degrees in addition to the phase settings of the antenna sections, cf. the dashed line as referred to above.

The radiation pattern of a sector antenna, especially in elevation, is characterized by having a main beam and side lobes. The very low gain between the main beam and the respective side lobes, and between side lobes, are often referred to as “nulls”. These nulls typically occur at n times the half-power beamwidth, n being an integer. The low antenna gain in these so called null directions results in low path gain which severely affects the transmission between a base station and a terminal and vice versa.

For antennas having normal (wide) elevation beam-widths, the direction of the first null, which normally is the most severe one, below the main beam, corresponds to distances from the site much less than to the cell boarder. Hence, the low antenna gain is compensated for by low path loss and there is no transmission problem in the mobile system.

For a high gain antenna, on the other hand, which typically has a very narrow beam-width in elevation, the consequence will be that the first null occurs relatively close to the main beam corresponding to a relatively large distance as compared to the cell range. This means that the lower antenna gain will not be sufficiently compensated for by a lower path loss. This may lead to poor coverage in some areas within the cell. It is very important that a transmitted signal covers the whole cell (or as much as possible of the cell). Therefore, in order to prevent for poor coverage, a technique called “null-filling” can be applied. This means that the radiation pattern is designed such that the gain drop in some or particularly some selected null directions is limited to an acceptable level.

Hence, for normal, short antennas the problem of the occurrence of “nulls” is not so serious since they have wide beams, whereas for high gain antennas having narrow beam-width in elevation, this problem will be much more serious.

FIG. 11 is an elevation cut showing the radiation pattern from a base station 10D with a high gain antenna arrangement 10′ which hence has a narrow beam-width in elevation. B_{NF}, i.e. the dashed line, shows a radiation pattern with a null towards a terminal MS for example located along the dashed dotted line, i.e. without null-filling. B_{F0} (solid line) illustrates filling of the first null below the main beam, i.e. some kind of null-filling has been implemented, hence making it possible for the MS to communicate with the base station, which would not have been possible if there were no null filling. Θ is the angle between the substantially vertical straight line and on which the antenna arrangement 10′ is mounted and the center of the main beam.

Several different techniques can be implemented for achieving null-filling and which are applicable for high gain antennas.

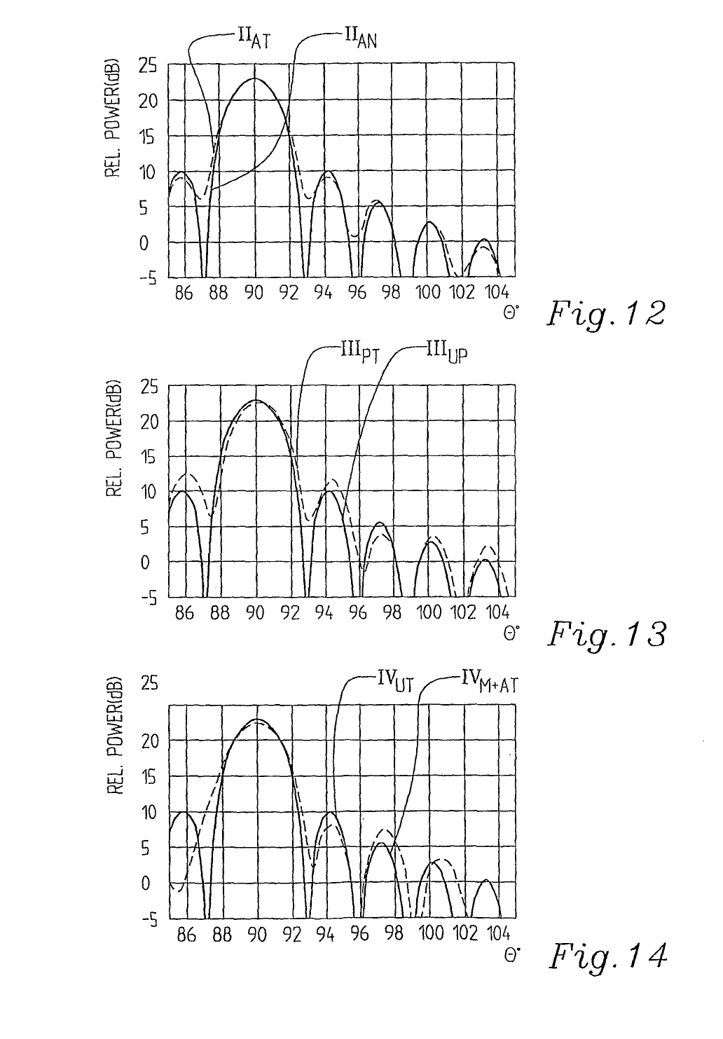

In order to reduce the nulls in a radiation pattern, a non-equal power distribution can be provided to the respective antenna sections. FIG. 12 is diagram illustrating the radiation pattern in relative power in dB versus Θ°, (Θ as defined in FIG. 11) with null-filling using amplitude taper, the dashed line II_{AT}, as compared to when no amplitude taper is implemented, solid line II_{AN}, for an antenna arrangement (not shown) comprising three identical antenna sections having a relative amplitude taper of 0 dB, −3 dB and −6 dB. In this arrangement it is supposed that each antenna section consists of eight radiation elements spaced 0.82 wavelengths apart. It should be clear that that the arrangement can be combined with for example mechanical and/or electrical tilting as discussed earlier in the application.

FIG. 13 is a diagram describing the radiation pattern, relative power in dB versus Θ as defined in FIG. 11, for another arrangement providing for null-filling and which is based on the use of the non-equal phase distribution between antenna sections, which hence describes another method for reducing nulls in a radiation pattern. In the arrangement (not shown) it is supposed that three identical antenna sections are used, for example similar to the arrangement in FIG. 12, but which here have no amplitude taper but instead a relative phase taper of 0°, −30° and 0°. In the figure the dashed line III_{PT}, relates to an implementation with a phase taper as compared to uniform taper, solid line III_{UT}, i.e. without any null-filling.

Alternatively it is possible to tilt the antenna sections of the antenna arrangement differently mechanically in order to reduce the nulls in a radiation pattern.

FIG. 14 schematically illustrates the radiation pattern as relative power in dB versus Θ for an arrangement wherein three antenna sections as discussed with reference to FIGS. 12, 13 are mechanically tilted α at 0°, 0° and +2° relative the vertical plane. Similar to the embodiment of FIG. 12, a relative amplitude taper is added, which is 0 dB, 0 dB, −6 dB. The solid line in the figure illustrates a corresponding arrangement with no mechanical tilt and no amplitude taper IV_{UT}, whereas the dashed line IV_{M+AT}, relates to the embodiment described above comprising a mechanical tilt and amplitude taper.

In other implementations one or more nulls in a radiation pattern can be reduced by means of electrically tilting the antenna sections differently. In an advantageous embodiment the selected tilt is combined with a phase taper between the antenna sections.

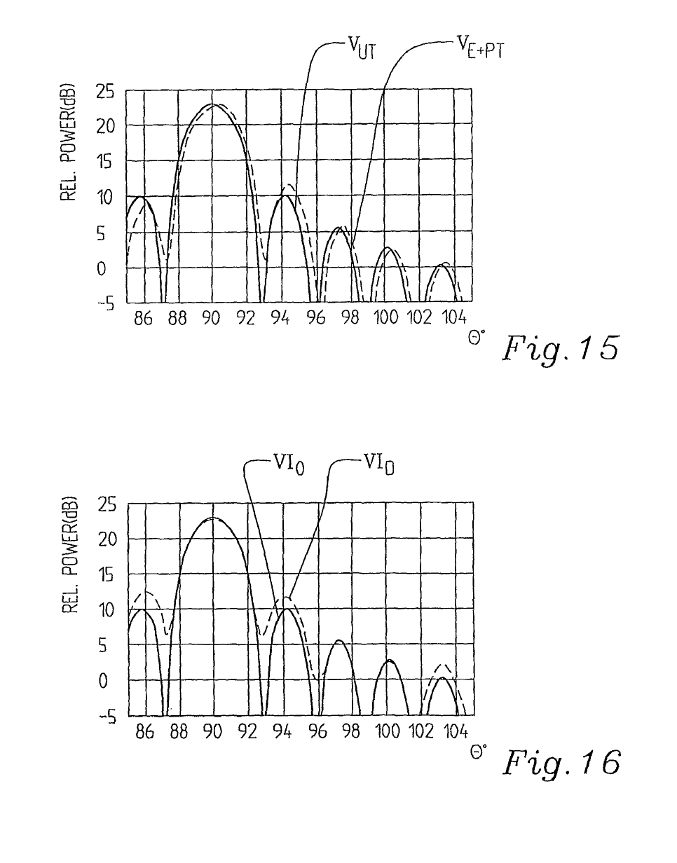

In FIG. 15 a diagram is illustrated describing the radiation pattern for an arrangement as discussed above comprising three antenna sections which are electrically tilted 0°, 0° and +1°, wherein, in addition thereto, a relative phase taper of 0°, 0° and 20° is applied. The dashed line V_{E+PT}, illustrates the relative power for the arrangement including an electrical beam tilt and phase taper whereas the full line V_{UT}, is a comparison with a corresponding arrangement but wherein no beam tilt and no phase taper is applied.

Still further null-filling can be achieved through the use of non-equal spacings between antenna sections as referred to and discussed with reference to FIG. 7.

FIG. 16 is a diagram describing the radiation pattern (dashed line VI_{D}) for the case when one antenna section is displaced a length corresponding to the length, or width of a half section as discussed with reference to FIG. 7, as compared to the solid line VI₀ which describes the radiation pattern when there is no displacement. It shall be clear that other antenna arrangements can be implemented with other antenna section spacings.

As can be seen from the various diagrams, the nulls can be efficiently reduced through the implementation of any of the above mentioned null-filling techniques. However, it is also possible to implement other null-filling techniques; for example the nulls in a radiation pattern can be reduced through connecting non-identical antenna sections, cf. FIG. 8.

Still further the nulls in a radiation pattern can be reduced through connection of antenna sections having different (dual) radiation pattern polarizations.

A non-identical (dual) polarization can also be provided for beam forming purposes and FIG. 17 illustrates an antenna arrangement 600 with three dual polarized antenna sections 10H₁, 10H₂, 10H₃ mounted on an antenna mast 40H or similar and being connected to a first feeding network 20H₁ comprising a power splitter/combiner, via feeding cables 21H₁₁, 21H₁₂, 21H₁₃ which have non-equal lengths, and also connected to a second feeding network 20H₂ comprising a power splitter/combiner, via feeding cables 21H₂₁, 21H₂₂, 21H₂₃ which also have non-equal lengths. The first feeding network 20H₁ feeding an RF signal is in turn fed by a feeder cable 30H₁, which signal is transmitted/received via a first polarization, whereas a feeder cable 30H₂ feeds the second feeding network 20H₂ with an RF signal transmitted/received via a second polarization. Hence two separate feeding networks 20H₁, 20H₂ feed two polarizations to the entire antenna arrangement. The feeding networks 20H₁, 20H₂ can be individually optimized to provide a particular desired elevation beam pattern for the respective polarization.

In one embodiment the two radiation patterns are designed to have a complementary elevation coverage, so that when both polarizations are fed using the same RF signal, a combined pattern being the power sum of the two polarization specific patterns is generated, the power-summed pattern having a new set of desired characteristics, such as for example no null depths.

By using multi-port elevation feeding networks, based on for example Butler matrix networks, multiple beams can be provided for each polarization, thereby allowing two or more beams to be generated using the above-mentioned power summation of polarization specific radiation patterns.

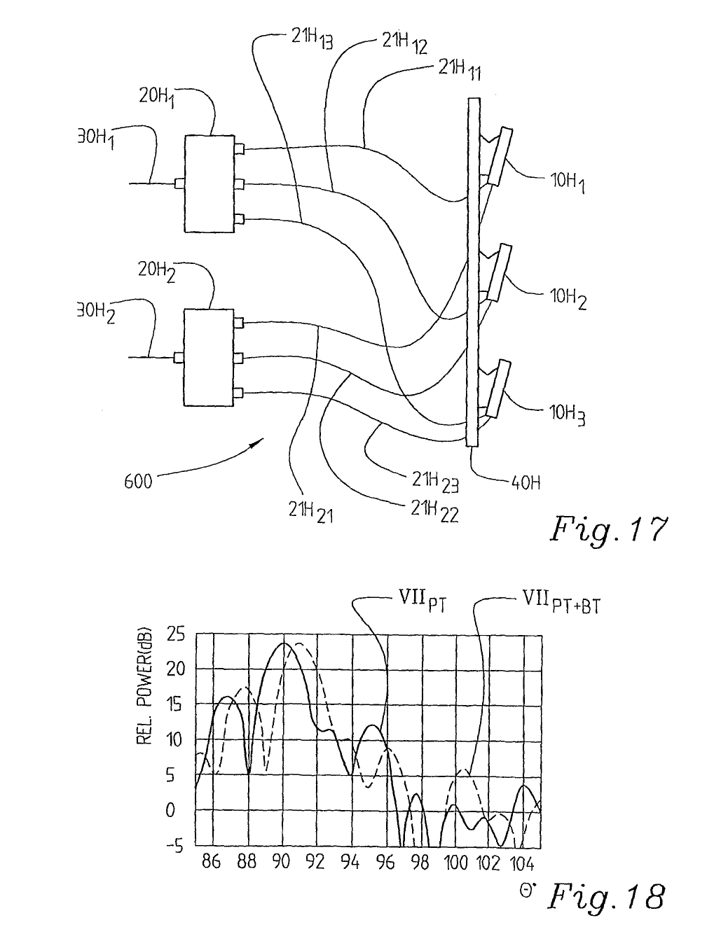

FIG. 18 is a diagram describing the radiation pattern with null-filling combined with electrical beam tilt, dashed line VII_{PT+BT}, compared to, solid line, where no beam tilt is implemented. The arrangement referred to in FIG. 18 (not shown) describes an embodiment in which a null-filling technique is combined with beam tilt. Null-filling is here achieved with phase only tapering between four identical antenna sections each comprising eight radiation elements. The first and the second nulls below the main beam are filled in and the beam can be scanned electrically by applying a phase gradient between the antenna sections with hardly any effect on the first filled nulls.

It should hence be clear that the inventive concept can be varied in a large number of ways without departing from the scope of the appended claims. It should also be clear that the invention is not limited to any particular number of antenna sections but there may be 2, 3, 4, 5, 6, 7, 8 etc. depending on application. It is also not limited to a particular number of radiation elements in an antenna section and they may be provided in many different kinds or sizes.

Still further many different tilting and/or null-filling techniques can be combined in any desired manner and mechanical and electrical tilt can be combined in any appropriate way, the distances between one or more of the antenna sections can be varied; it may be different between only two or between three antenna sections, or it may be different between any pair of antenna sections as well as the antenna sections may be identical for example non-equal sub-array lengths for the different antenna sections, or not, and different sizes may be combined with different distances and different degrees of mechanical tilting. Additionally, or alternatively some of the antenna sections (or all) may comprise built in electrical tilt and/or electrical tilting provided for by other means as discussed earlier, and or any kind of null-filling and dual polarization may be implemented. Also in other aspects, the invention is not limited to the specifically illustrated embodiments. One advantage, in addition to other advantages referred to in the document, is that the antenna arrangement can be mounted on different kind of structures, irregular or regular or of a given shape, vertical or inclined etc.

1. An antenna arrangement comprising an antenna section, said antenna section comprising a number of radiating elements which may be arranged in arrays or sub-arrays, characterized in
that it comprises at least one further antenna section, that said at least two antenna sections are mounted substantially along a straight line, a non-straight line or irregularly at a mounting structure, that it comprises a feeding network arrangement for feeding said at least two antenna sections with feeding network control means for controlling the feeding of the antenna sections allowing for beam forming control and in that the feeding network arrangement comprises two feeding networks, each feeding the antenna sections with a respective, different polarization.

2. The antenna arrangement according to claim 1, characterized in that at least two of said number of antenna sections are substantially identical.

3. The antenna arrangement according to claim 2, characterized in that all antenna sections are substantially identical.

4. The antenna arrangement according to claim 1,
characterized in that at least two antenna sections are non-identical, i.e. different.

5. The antenna arrangement according to claim 1, characterized in that all antenna sections are non-identical.

6. The antenna arrangement according to claim 1, characterized in that the antenna sections are so mounted that a or the spacing(s) between respective adjacent antenna sections are substantially equal.

7. The antenna arrangement according to claim 1, characterized in that the antenna sections are so mounted that the spacings between respective adjacent antenna sections are different.

8. The antenna arrangement according to claim 1, characterized in that the antenna sections comprise conventional sector antennas, e.g. with a 45°, 60° or 90° beamwidth in azimuth.

9. The arrangement according to claim 1, characterized in that the feeding network arrangement comprises means for variably controlling the phase and/or the amplitude between the antenna sections hence providing for phase and/or amplitude tapering.

10. The arrangement according to claim 1, characterized in that it comprises means for tilting the beam in relation to the normal of a real or virtual mounting plane on which carrying means, e.g. a mast, is mounted for carrying said antenna sections.

11. The arrangement according to claim 10, characterized in that the means for tilting the beam comprise mechanical tilting means for mechanically tilting the antenna sections.

12. The arrangement according to claim 11, characterized in that at least two, preferably all, antenna section are individually mechanically tilted.

13. The arrangement according to claim 1, characterized in that at least some of the antenna sections are electrically pre-tilted, i.e. comprise a “built-in” tilt, which may be the same or different for different antenna sections.

14. The arrangement at least according to claim 10, characterized in that the means for tilting the beam comprises means for electrically tilting the antenna sections.

15. The arrangement according to claim 14, characterized in that the means for electrically tilting the antenna sections are capable of tilting each antenna section individually, i.e. comprises means for individually and separately controlling each antenna section.

16. The arrangement according to claim 15, characterized in the feeding network arrangement comprises phase delaying means and/or time delaying means and in that electrical tilting of antenna sections is achieved by introducing phase delays and/or time delays to the respective antenna sections.

17. The arrangement according to claim 1, characterized in that the same signal is used to feed a first and a second polarization, that the respective feeding networks comprise control means for controlling the elevation beam pattern of the respective polarizations, particularly to obtain elevation beam patterns of the respective polarizations which have a complementary elevation coverage, such that a combined pattern being the power sum of the respective elevation beam patterns is generated.

18. The arrangement according to claim 17, characterized in that each feeding network comprises a multi-port-elevation feeding network e.g. based on a Butler matrix network.

19. The arrangement according to claim 1, characterized in that the/each feeding network comprises power splitting means for appropriately splitting the power fed to the respective antenna sections.

20. The arrangement according to claim 1, characterized in that it comprises beam forming means for controlling the radiation pattern such that the gain can be controlled in order to limit gain drop at least in one selected direction, i.e. to provide for “null-filling” in said at least one direction.

21. The arrangement at least according to claim 20, characterized in that said beam forming means comprises one or more of means for mechanically and/or electrically tilting the beam.

22. The arrangement according to claim 1, characterized in that the antenna sections are such, or so disposed, that the radiation pattern can be controlled such that gain drop can be limited/prevented in at least one selected direction.

23. The arrangement according to claim 22, characterized in that at least one antenna section is different from one or more of the other antenna sections and/or that at least one antenna section is so disposed that the distance to an adjacent antenna section differs from the distance between at least two other antenna sections or between said antenna section and another adjacent antenna section.

24. The arrangement according to claim 20, characterized in that said feeding network arrangement comprises two separate feeding networks (20H₁, 20H₂), each of which feeding each of the antenna sections with dual polarizations.

25. The arrangement according to claim 1, characterized in that the antenna sections comprise separate units.

26. The arrangement according to claim 1, characterized in that it comprises 2, 3, 4, 5, 6 or 7 antenna sections, mounted on a common mast or any other mounting structure.

27. The arrangement according to claim 1, characterized in that it is used for transmitting or for receiving or for transmitting and receiving signals.

28. The antenna arrangement according to claim 1, characterized in that the antenna sections may be mounted at a non-planar surface, the antenna sections e.g. being mounted with non-equal orientations.

29. The use of an arrangement according to claim 1, in a radio base station of a cellular mobile communication system.

30. A method for controlling beam forming in an antenna arrangement comprising a number of antenna sections, each antenna section comprising a number of radiating elements which may be arranged in sub-arrays, characterized in that at least two antenna sections are mounted substantially along a straight line or irregularly at a mounting structure and in that the method comprises the steps of:
feeding the antenna sections by means of a feeding network, by:
using a first feeding network for feeding a signal to elements having a first polarization in all antenna sections,
using a second feeding network for feeding the same signal to elements having a second polarization in all antenna sections
controlling the feeding while mechanically and/or electrically applying an individual beam tilt to the respective antenna sections in order to control the gain and/or beam form.

31. The method according to claim 30, characterized in that it comprises the step of:
compensating for displacements of the phase fronts from the respective antenna sections caused by mechanical tilt and/or electrical pre-tilt using the feeding network.

32. The method according to claim 30, characterized in that it comprises the step of:
applying individual time delays and/or phase shifts to the respective antenna sections in order to provide for electrical beam tilting.

33. The method according to claim 30, characterized in that it comprises the step of:
using multi-port elevation feeding networks, e.g. based on Butler matrix networks, to provide multiple beams for each polarization.

34. The method according to claim 30, characterized in that it comprises the step of:
manually, or via a remote control unit, controlling the feeding network arrangement.
